(19) United States
(12) Patent Application Publication
(10) Pub. No.: US 2015/0063452 A1
(43) Pub. Date: Mar. 5, 2015

(54) HIGH EFFICIENCY VIDEO CODING (HEVC) INTRA PREDICTION ENCODING APPARATUS AND METHOD

(71) Applicant: ELECTRONICS AND TELECOMMUNICATIONS RESEARCH INSTITUTE, Daejeon (KR)

(72) Inventors: Ig Kyun KIM, Daejeon (KR); Kyung Jin BYUN, Daejeon (KR); Nak Woong EUM, Daejeon (KR)

(73) Assignee: ELECTRONICS AND TELECOMMUNICATIONS RESEARCH INSTITUTE, Daejeon (KR)

(21) Appl. No.: 14/304,405

(22) Filed: Jun. 13, 2014

(30) Foreign Application Priority Data
Sep. 4, 2013 (KR) 10-2013-0106012

(51) Int. Cl. H04N 19/593; H04N 19/61; H04N 19/186; H04N 19/124; H04N 19/96; H04N 19/182

(52) U.S. Cl. CPC H04N 19/00763; H04N 19/00969; H04N 19/00303; H04N 19/00315; H04N 19/0009; H04N 19/00781
USPC 375/240.12

(57) ABSTRACT

Disclosed is a residual signal inter-channel intra prediction encoding method between a residual signal of a luminance component of an image and a residual signal of a chrominance component thereof. It is possible to improve an intra prediction encoding performance when the inter-channel prediction is performed between residual signal of the luminance component and the chrominance component of HEVC, and derive a prediction coefficient for linear prediction at a high speed while the quadtree block structure of the HEVC is not changed. In addition, it is advantageous to avoid degradation in inter-channel prediction performance, which is caused when quadtree block structures of prediction units (PUs) of the luminance component and the chrominance component are different.

### CROSS-REFERENCE TO RELATED APPLICATIONS

This application claims priority under 35 U.S.C. §119 to Korean Patent Application No. 10-2013-0106012, filed on Sep. 4, 2013, the disclosure of which is incorporated herein by reference in its entirety.

### TECHNICAL FIELD

The present invention relates to a video encoding apparatus and method, and more particularly, to an enhanced high efficiency video coding (HEVC) intra prediction encoding apparatus and method.

### BACKGROUND

High Efficiency Video Coding (HEVC), which is a video encoding scheme, is a successor to H.264/AVC and Joint Collaborative Team on Video Coding (JCT-VC) is developing the HEVC standard for a YUV420 image.

In particular, unlike H.264/AVC, Coding Unit (CU) based on a variable size and Quadtree Block based on Quadtree structure have been proposed and employed instead of Macro Block (MB) having a fixed size.

In addition, in JCT-VC, a scheme of reducing redundancy using similarity between a luminance component and a chrominance component (that is, a pixel signal inter-channel prediction) has been also proposed and employed as one of intra-prediction tools. According to this scheme, a prediction coefficient is estimated from an encoded ambient signal, and thus it is possible to omit encoding of the prediction coefficient itself and significantly reduce an amount of codes. However, this scheme has limitations in that an accuracy of the prediction coefficient is low and a subjective quality is not good at a low bit rate.

Much review has been done on a prediction method using a correlation between a luminance component and a chrominance component in addition to the above prediction scheme between pixel signal channels. A scheme of forming a chrominance prediction signal using a linear prediction from a reconfigured luminance image, or a prediction model considering directionality included in an image signal have been proposed as a YUV444 encoding tool.

In addition, a scheme of adaptively select one of an intra-prediction and a luminance component-to-chrominance component prediction has been proposed for an RGB444 image.

As another inter-channel prediction for H.264/AVC, an encoding scheme for storing data is being reviewed for an RGB444 image in a super high-definition image, which is called Ultra HD. The super high-definition image has an increased number of areas (pixels) having the same characteristic and thus a higher inter-pixel correlation, thereby generally improving intra-prediction performance.

In H.264/AVC, since a large-sized block is easily selected, a complex texture edge that allows difficult prediction is generated as a residual signal when the prediction is performed in consideration of the direction. This results in increasing redundancy between the luminance component and the chrominance component. Thus, a scheme of predicting an intra-prediction differential signal using a correlation between the luminance component and the chrominance component has been proposed. This scheme is used by linearly predicting the intra-prediction residual signal of a prediction target signal from a reference signal to derive an optimum prediction coefficient at an encoding side.

However, since HEVC is for a YUV420 image and also employs a Quadtree block structure, this scheme may be applied without any change.

Pixel Signal Inter-Channel Prediction in H.264/AVC

This scheme linearly predicts a chrominance signal between channels using a reconfigured luminance signal. The luminance signal is matched to the chrominance signal with respect to the size and phase, and thus down-sized in a vertical direction and sub-sampled in a horizontal direction. The chrominance signal is predicted from the reconfigured luminance signal through Equation (1) below:

Rec′_{L}[x,y]=(Rec_{L}[2x,2y]+Rec_{L}[2x,2y+1] [symbol] 1

Pred_{C}[x,y]=α×Rec′_{L}[x,y]+β (1)

where Pred_{C} is a chrominance prediction signal in a current block to be encoded, and Rec′_{L} is a reconfigured luminance signal in the current block. The parameters a and β of the Equation (1) are calculated by an encoder and a decoder through the least square method, using the luminance signal and the chrominance signal surrounding the current block, which are completely encoded.

In the above-described scheme, there is a limitation in that the parameters are inaccurately deprived if there is no correlation between the current block and an area surrounding the current block even when there is a correlation between channels of the luminance component and the chrominance component of the current block. In addition, the parameters are calculated using an already quantized signal, thereby allowing parameter estimation to be inaccurate and allowing a subject quality to be limitedly improved.

Furthermore, each scheme, which is reviewed due to H.264/AVC FRExt, is for a 444 image. Thus, when the scheme is applied to a 420 image, the performance improvement is restrictive, and the amount of calculations is not effectively improved.

Residual Signal Inter-Channel Prediction in H.264/AVC

This scheme uses the intra correlation and the inter-channel correlation simultaneously. Thus the intra-prediction residual signal for the chrominance component is linearly predicted between channels, using a residual signal generated as a result of intra-prediction of the luminance component. Intra-prediction of the luminance component of H.264 has nine modes. However, the intra-prediction residual signal of the prediction target signal is predicted through Equation (2) below:

PredResi[x,y]=α×Resi[x,y]+β (2)

Where PredResi[x,y] is a prediction signal of the intra-prediction residual signal in the signal to be predicted. In a prediction mode of the signal to be predicted, an optimum prediction mode is encoded, but is not necessarily matched with a prediction mode of a reference signal. Accordingly, Resi is a prediction residual signal calculated applying the same prediction mode as that of the prediction signal to the reconfigured reference signal.

Prediction coefficient α is analytically derived by an encoder through the least square method using a residual signal after intra-encoding completion with respect to a reference signal (that is, a signal for a luminance component) and a residual signal before integer transformation and quantization with respect to a prediction target signal (that is, a signal for a chrominance component). Thereafter, the encoder estimates a prediction coefficient α of a current block using a prediction coefficient α of a surrounding block that is completed encoded and performs encoding by quantizing a difference between the estimated prediction coefficient α and the analytically derived value.

Since a predicted block size is greater than a transformed block size, a prediction coefficient β is equal to the same value in the transformed block and added only to a DC coefficient by integer transformation in a next stage. That is, a value obtained by adding β to the DC coefficient is encoded.

As such, encoding of a prediction coefficient derived from a signal before quantization is made in order to decrease an intra correlation by encoding an optimum prediction mode in a channel, decrease an inter-channel correlation by predicting a prediction residual signal of the prediction target signal, and increase predication accuracy. It is difficult to apply this method to the HEVC having a quadtree block structure.

### SUMMARY

Accordingly, the present invention provides an apparatus and method for performing prediction encoding between residual signals of a luminance component and a chrominance component by applying H.264 to a quadtree block of HEVC.

The present invention also provides an apparatus and method for performing prediction encoding between residual signal channels of HEVC, which is complementary to a related art prediction encoding scheme between H.264 pixel signal channels.

The object of the present invention is not limited to the aforesaid, but other objects not described herein will be clearly understood by those skilled in the art from descriptions below.

In one general aspect, an HEVC intra prediction encoding apparatus for encoding an image, the HEVC intra prediction encoding apparatus includes: a luminance signal encoder configured to generate a first residual signal for a luminance component of a current block (prediction unit (PU)) being encoded according a first intra prediction mode direction for the current block; a chrominance signal encoder configured to generate a second residual signal for a chrominance component of the current block according to a second intra prediction mode direction for the current block, and a residual signal prediction encoder configured to when a mode (hereinafter, referred to as a residual signal inter-channel prediction mode) of performing residual signal inter-channel prediction between a luminance residual signal and a chrominance residual signal of the current block is selected, generate a prediction residual signal for a residual signal of a chrominance component of the current block using the first residual signal and the second residual signal.

When the residual signal inter-channel prediction mode is selected, the first intra prediction mode direction may be the same as the second intra prediction mode direction.

When the residual signal inter-channel prediction mode is selected, encoding for the second intra prediction mode direction may be omitted.

When there is Transform Unit (TU) division in the current block, the residual signal prediction encoder derives the inter-channel prediction coefficient of the TU first encoded in the current block as an inter-channel prediction coefficient for the current block.

When the residual signal inter-channel prediction mode is selected, the residual signal prediction encoder may limit the TU division for the chrominance component in the current block.

The first residual signal may be a restored signal after integer transformation and quantization, and the second residual signal may be a signal before integer transformation and quantization.

When a quadtree block structure of a current block group for the luminance component is different from that for the chrominance component, the luminance signal encoder and the chrominance signal encoder may regenerate a first residual signal for the luminance component and a second residual signal for the chrominance component with respect to the current block group according to a third intra prediction mode direction of a left upper current block of the current block group of the luminance component.

In another general aspect, an HEVC intra prediction encoding apparatus for encoding an image, the HEVC intra prediction encoding apparatus includes: a prediction mode selection unit configured to provide an intra prediction mode including an inter-channel prediction mode (hereinafter, referred to as a residual signal inter-channel prediction mode) between a residual signal of a luminance component and a residual signal of a chrominance component with respect to a current bock (prediction unit (PU)) to be encoded; and a prediction residual signal generation unit configured to, when the residual signal inter-channel prediction mode is selected, generate a prediction residual signal for the residual signal of the chrominance component of the current block using a first residual signal of the luminance component generated according to a first intra prediction mode direction of the current block and a second residual signal of the chrominance component generated according to a second intra prediction mode direction of the current block.

When the residual signal inter-channel prediction mode is selected, the first intra prediction mode direction may be the same as the second intra prediction mode direction.

When the residual signal inter-channel prediction mode is selected, encoding for the second intra prediction mode direction may be omitted.

The HEVC intra prediction encoding apparatus may further include a block division unit configured to determine a quadtree block structure for the luminance component and the chrominance component of the current block, in which when there is Transform Unit (TU) division for the luminance component or chrominance component in the current block, the prediction residual signal generation unit derives an inter-channel prediction coefficient of the TU first encoded in the current block as an inter-channel prediction coefficient for the current block.

When the residual signal inter-channel prediction mode is selected, the block division unit may limit the TU division for the chrominance component in the current block.

The first residual signal may be a restored signal after integer transformation and quantization, and the second residual signal may be a signal before integer transformation and quantization.

In still another general aspect, an HEVC intra prediction encoding method for encoding an image, the HEVC intra prediction encoding method includes: providing an intra prediction mode including an inter-channel prediction mode between residual signals of the luminance component and the chrominance component with respect to a current block (prediction unit (PU)) to be encoded; when the residual signal inter-channel prediction mode is selected, generating a first residual signal for a luminance component of the current block according a first intra prediction mode direction; generating a second residual signal for a chrominance component of the current block according to a second intra prediction mode direction; and generating a prediction residual signal for a residual signal of a chrominance component of the current block using the first residual signal and the second residual signal.

The HEVC intra prediction encoding method may further include determining a quadtree block structure of a current block group for the luminance component and a quadtree block structure of a current block group for the chrominance component and determining a quadtree block structure for the luminance component and the chrominance component of the current block.

When there is Transform Unit (TU) division in the current block, the generating of the prediction residual signal may include deriving the inter-channel prediction coefficient of the TU first encoded in the current block as an inter-channel prediction coefficient for the current block.

When the residual signal inter-channel prediction mode is selected, the generating of the prediction residual signal may include limiting the TU division for the chrominance component in the current block.

When a quadtree block structure of a current block group for the luminance component is different from that for the chrominance component, the HEVC intra prediction encoding method may further include regenerating a first residual signal for the luminance component and a second residual signal for the chrominance component with respect to the current block group according to a third intra prediction mode direction of a left upper current block of the current block group for the luminance component.

Other features and aspects will be apparent from the following detailed description, the drawings, and the claims.

### BRIEF DESCRIPTION OF THE DRAWINGS

FIGS. 1 and 2 are views illustrating a relation between LCU, CU, PU, and TU of HEVC.

FIG. 3 is a view illustrating an example of a PU division structure when PART_N×N mode is selected in CU of a HEVC quadtree block structure.

FIG. 4 is a block diagram showing an internal configuration of an HEVC encoding apparatus according to an embodiment of the present invention.

FIG. 5 is a view showing an example in which TU division is limited according to an embodiment of the present invention.

FIG. 6 is a block diagram showing an internal configuration of an HEVC encoding apparatus according to another embodiment of the present invention.

FIG. 7 is a flowchart illustrating an HEVC encoding method according to still another embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

A video encoding apparatus that will be described later may be one of a user terminal such as a personal computer (PC), a laptop computer, a personal digital assistant (PDA), a portable multimedia player (PMP), a PlayStation Portable (PSP), a wireless communication terminal, a smart phone, and a TV, a server terminal such as an application server and a service server, and various apparatuses including a communication device, such as a communication modem, for performing communication with various equipment or wired/wireless communication networks, a memory for storing various programs and data used to encode or decode the image or perform inter or intra-prediction for encoding or decoding, a microprocessor for executing programs to perform operation and control, and so on.

In addition, an image encoded by an image encoding apparatus into a bit stream may be transmitted in real time or non-real time to an image decoding apparatus through a wired/wireless communication network, such as Internet, a local are network (LAN), a wireless LAN, a Wibro network, and a mobile communication network or through a variety of communication interfaces such as a cable, a universal serial bus (USB), and so on, decoded by the image decoding apparatus, and restored and replayed.

Most video compression algorithms that are typically used perform compression for each channel Y, U, and V separately. However, a general color image or video has a correlation between image signals for each channel R, G, and B or Y, U, and V. Actually, for many application programs, much research has been done in order to enhance performance of each application program, using the correlation for each channel.

It is assumed in a typical video compression research that a YUV color domain is used, and each signal is decorrelated from each other. In addition, since a U signal and a V signal have resolutions less than a Y signal (4:2:0 format), most compression algorithms have more focus on the Y signal than the U signal and the V signal. However, as seen in another actual application, the U signal and the V signal still have a strong correlation with the Y signal, and thus more enhanced compression performance can be expected using the correlation.

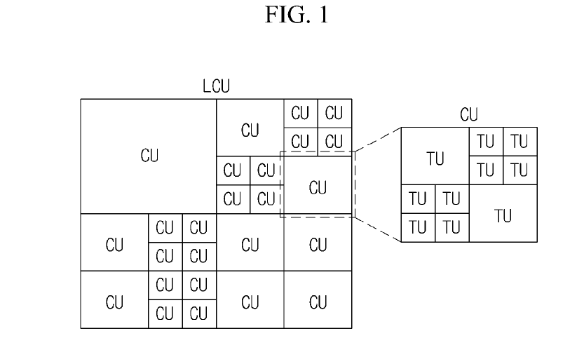

A quadtree block structure using an encoding method according to the present invention will be described before the encoding method is described. FIGS. 1 and 2 are views illustrating a relation between LCU, CU, PU, and TU of HEVC.

Recursive Division Structure in HEVC

In HEVC, an image slice is divided into large coding units (LCUs) having a minimum size of 8×8 or a maximum size of 64×64. Each LCU may be recursively divided into areas that is called a coding unit (CU) in a quadtree form until the minimum size of each area is 8×8. An inter prediction or intra-prediction is applied to each CU to generate a residual signal.

The generated residual signal is recursively divided into areas, each of which is called a transform unit, in a quadtree form, and then transformation appropriate for a size of the TU is performed. Accordingly, unlike H.264/AVC, HEVC allows transformations having various sizes to be applied to the areas in one CU, using the flexible division method. HEVC includes transformations having a minimum size of 4×4 to a maximum size of 32×32. Thus the transformations may be mixed as an optimum combination and used in one CU.

More specifically, JCT-VC has proposed three kinds of units as an encoding processing unit that is substituted for a macro block of the H.264/AVC. Each of these units has a recursive division structure as shown in FIG. 2. Here, however, only an intra frame will be described.

First, there is a CU that is a processing unit substituted for a macro block and formed in a quadtree structure. Next, only one single layer of prediction unit PU sharing prediction signal information is introduced into each CU. That is, there are two kinds of modes: PART_{—}2N×2N mode in which the size of the CU is the same as that of the PU and PART_N×N mode (corresponding to a PU block in a right lower portion of (b) of FIG. 2) in which the CU is divided into 4 PUs. PART_{—}2N×2N mode can be selected only when the size of CU is twice greater than a minimum transformation size.

Each PU is divided into Transform Units (TUs), each of which is a unit of actual prediction or transformation processing. The PU may be recursively divided to have a minimum transformation size, such as in a left lower TU block of (c) of FIG. 2.

Two matters should be further considered in addition to application of H.264 expansion, in order to apply prediction coding between residual signal channels to a quadtree block structure of HEVC.

(A) The prediction coefficient α cannot be derived using the minimum square method when the size of the PU is different from that of the TU.

PU is positioned at a position that is called a TU group for sharing prediction information. That is, since the prediction processing is performed in units of TUs instead of PUs, an optimum value of the prediction coefficient α is different for each TU. When an optimum prediction coefficient is encoded for each TU, it is disadvantageous in that additional information is increased.

Conversely, a prediction coefficient α is encoded in units of TUs, the additional information is decreased, however, another problem may occur when the prediction coefficient α is determined. That is, it is impossible to calculate the prediction coefficient α using an analytical method such as the least square method because a TU block to be encoded needs to be considered.

(B) PART_N×N has a limitation in that a correlation between residual signals of the luminance component and the chrominance component, which are generated as a result of the intra-prediction encoding, becomes low because prediction directions of the luminance component and the chrominance component are different.

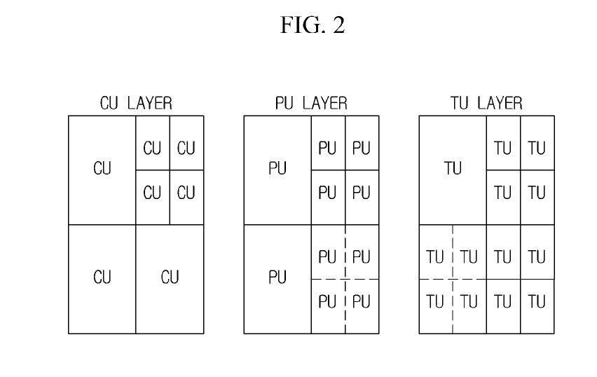

If PART_N×N is selected in CU, the luminance component (first block of FIG. 3) includes 4 PUs and the chrominance component (second and third blocks of FIG. 3) includes only one PU. Thus PU structures of the luminance component and the chrominance component becomes different. In addition, the CU being divided into 4 PUs denotes that prediction directions of the 4 PUs are not the same. As such, if the prediction directions of the luminance component and the chrominance component are different, a characteristic of a residual signal generated as a result of the intra-prediction, thereby significantly decreasing inter-channel prediction performance.

As such, actually, a typical intra-prediction encoding method using a correlation between channels cannot be applied to HEVC having a quadtree block structure without any change. Accordingly, the typical intra-predication encoding method needs to be adaptively applied to the quadtree structure of HEVC. Hereinafter, an encoding apparatus and method for predicting a residual signal of the chrominance component using a residual signal of the encoded luminance component will be described which is adapted to the quadtree block structure.

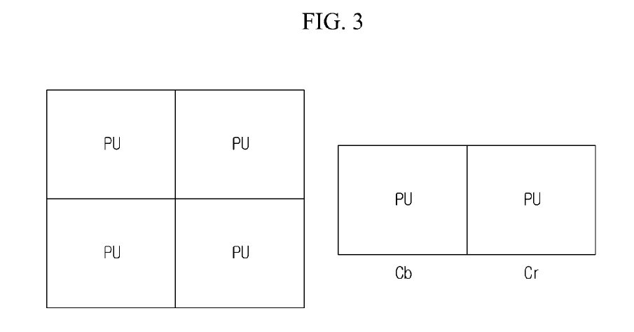

FIG. 4 is a block diagram schematically showing an internal configuration of an HEVC encoding apparatus according to an embodiment of the present invention.

An HEVC encoding apparatus according to an embodiment of the present invention includes a luminance signal encoder 100 configured to perform encoding on a luminance signal of an image, a chrominance signal encoder 200 configured to perform encoding on a chrominance signal of an image, and a residual signal prediction encoder 300 configured to generate a prediction residual signal of a chrominance component residual signal of an image.

The luminance signal encoder 100 generates a first residual signal for a luminance component of the current block according to a first intra-prediction mode direction for the current block (prediction unit (PU)) to be encoded.

Specifically, the luminance signal encoder 100 may includes an intra-prediction unit 110, a subtractor 120, a transformation/quantization unit 130, an entropy encoding unit 140, an inverse transformation/inverse quantization unit 150, an adder 160, a deblocking filter 170, and a block division unit 180.

The intra-prediction unit 110 performs intra-frame prediction on a luminance component signal of the current block in units of pixels, thereby removing spatial redundancy from a corresponding frame.

The intra-prediction unit 110 selects one of 35 kinds (33 direction, DC, and Planar) of prediction modes defined in luminance intra-prediction of HEVC and generates an prediction signal for a luminance component of the current block in units of pixels according to the selected prediction mode direction (first intra-prediction mode direction).

According to an embodiment of the present invention, a mode (hereinafter, residual signal inter-channel prediction mode) of performing residual signal inter-channel prediction between a luminance residual signal and a chrominance residual signal of the current block is further provided in addition to 35 kinds of prediction modes defined in the luminance intra prediction. The residual signal inter-channel prediction mode is determined by a rate-distortion optimization of an image. However, in an embodiment of the present invention, it is assumed that the residual signal inter-channel prediction mode is selected.

The subtractor 120 generates a residual signal (first residual signal) corresponding to a difference between a prediction signal of the current block, which is generated by the intra-prediction unit 110, and an original signal.

The transformation/quantization 130 performs frequency transformation and then quantization on the first residual signal generated by the subtractor 120. That is, transformation/quantization 130 divides the transformed frequency component value by a quantization parameter and approximates the result to an integer value.

The entropy encoding unit 140 performs entropy encoding on values quantized by the transformation/quantization unit 130 to generate and output a bit stream.

The inverse transformation/inverse quantization unit 150 performs inverse-quantization on the values quantized by the transformation/quantization unit 130 to multiply the approximated integer values by a quantization parameter to restore the frequency component values. The inverse transformation/inverse quantization unit 150 transforms the restored frequency component values from a frequency space to a color space to restore the first residual signal.

The adder 160 adds the prediction signal generated by the intra-prediction unit 110 and the restored first residual signal generated by the inverse transformation/inverse quantization unit 150 to generate a luminance component signal of the restored current block.

The deblocking filter 170 reduces a distortion of a block boundary of the luminance component signal of the restored current block generated by the adder 160, thereby enhancing image quality.

When the intra-prediction encoding is performed on the luminance component signal, the block division unit 180 determines a quadtree block structure of the current block group for the luminance component to be encoded and a quadtree block structure for a luminance component of the current block.

As described below with reference to FIGS. 1 and 2, HEVC have employed a recursive division structure, and thus allows division and transformation having various sizes to be applied for each area in one CPU. HEVC includes transformations having a minimum size of 4×4 to a maximum size of 32×32. Thus the transformations may be mixed as an optimum combination and used in one CU.

The restored first residual signal generated by the inverse transformation/inverse quantization unit 150 is input to the residual signal prediction encoder 300 and used to predict the residual signal for the chrominance component of the current block. This will be described below in detail.

Next, the chrominance signal encoder 200 generates a second residual signal for a chrominance component of the current block according to a second intra-prediction mode direction for the current block (prediction unit (PU)) to be encoded.

Specifically, the luminance signal encoder 200 may includes an intra-prediction unit 210, subtractors 220 and 230, a transformation/quantization unit 240, an entropy encoding unit 250, an inverse transformation/inverse quantization unit 260, an adder 270, a deblocking filter 280, and a block division unit 290.

The intra-prediction unit 210 selects one of 6 kinds (vertical direction, horizontal direction, DC, Planar, DM, and LM) of prediction modes defined in chrominance intra-prediction of HEVC and generates an prediction signal for a chrominance component of the current block in units of pixels according to the selected prediction mode direction (second intra-prediction mode direction). Here, the second intra-prediction mode direction is the same as the first intra-prediction mode direction for the chrominance component even when the residual signal inter-channel prediction mode is selected according to an embodiment of the present invention. Accordingly, information about the second intra prediction mode direction needs not to be encoded.

The subtractor 220 generates a residual signal (second residual signal) corresponding to a difference between a prediction signal of the current block, which is generated by the intra-prediction unit 210, and an original signal. Here, the second residual signal is input to the residual signal prediction encoder 300 and used to predict the residual signal for the chrominance component of the current block. This will be described below in detail.

Since other elements of the chrominance signal encoder 200 are the same as those of the luminance signal encoder 100, the detailed description thereof will be omitted.

Next, when the residual signal inter-channel prediction mode is selected, the residual signal prediction encoder 300 generates a prediction residual signal for a residual signal of the chrominance component of the current block using the first residual signal and the second residual signal.

Here, the first residual signal is a restored signal after integer transformation and quantization, and the second residual signal is a signal before integer transformation and quantization.

Specifically, the residual signal prediction encoder 300 performs linear prediction on the prediction residual signal for the chrominance component residual signal, using Equation (3) below:

Resi′_{L}[x,y]=(Resi_{L}[2x,2y]+Resi_{L}[2x,2y+1]) [symbol] 1

PredResi_{C}[x,y]=α_{C}×Resi′_{L}[x,y]+β_{C} (3)

where PredResi_{C}[x,y] is a prediction signal for the chrominance component residual signal, and Resi′_{L} is a residual signal for the chrominance component that has been encoded and then restored. The prediction coefficient α_{C} has the same value for each pixel in the TU, which is an actual encoding unit in HEVC, and thus is added by only a DC coefficient through DTC integer transformation.

Accordingly, the residual signal prediction encoder 300 needs not to explicitly calculate a predication coefficient α_{C} for each pixel and also needs not to encode only β_{C}. That is, a value obtained by adding β_{C} to the DC coefficient is encoded.

Furthermore, the value obtained by adding β_{C} to the DC coefficient converges to a value obtained considering a quantization error in α_{C} in order to perform derivation after applying a quantized α_{C}. Accordingly, an actual prediction equation is the same as Equation (4) below.

PredResi_{C}[x,y]=α_{C}×Resi′_{L}[x,y] (4)

As such, when the residual signal prediction encoder 300 performs linear prediction on the prediction residual signal of the chrominance component, using the restored first residual signal and a prediction coefficient calculated in the least square method.

The residual signal prediction encoder 300 performs calculation on the prediction residual signal for the linearly predicted chrominance component and the second residual signal (an original residual signal for the chrominance component) inputted by the chrominance signal encoder 200 using the subtractor to generate a new residual signal to encode the new residual signal into a bit stream through integer transformation and quantization (not shown).

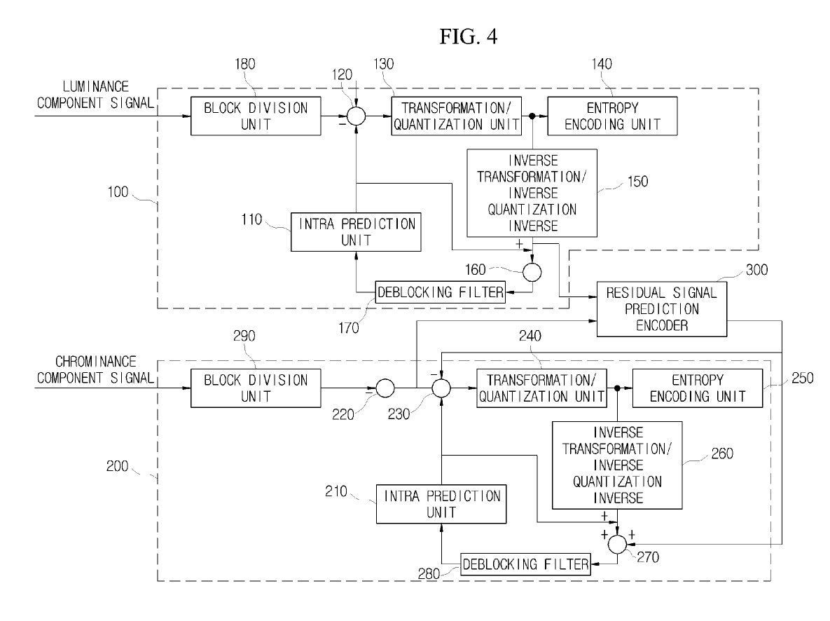

A prediction residual signal generation method adapted to a quadtree block structure of the HEVC according to an embodiment of the present invention will be described below with reference to FIG. 5.

FIG. 5 is a view illustrating an example in which TU division is limited according to an embodiment of the present invention.

As an example, when there is Transform Unit (TU) division in the current block, the residual signal prediction encoder 300 may derive the inter-channel prediction coefficient of the TU first encoded in the current block as an inter-channel prediction coefficient for the current block.

To quantize the prediction coefficient, in principle, the residual signal prediction encoder 300 should perform the least square method on all pixels constituting the current block to determine a prediction coefficient through rate distortion optimization. In this case, the encoding time may increase.

In addition, since the decoder is not affected by how the encoder deprives the prediction, it is efficient to deprive the inter-channel prediction coefficient of the TU that is first encoded according to an embodiment as the inter-channel prediction coefficient for the current block. In this case, other than PART_N×N (CU is divided into 4 PUs), the consistency of the quadtree block structure of the luminance component and the chrominance component can be maintained.

In another embodiment, when the residual signal inter-channel prediction mode is selected, the residual signal prediction encoder 300 may limit the TU division for the chrominance component in the current block. As an example, the residual signal prediction encoder 300 delivers an instruction for limiting the TU division to the block division unit 290.

According to this scheme, TU division of the chrominance is not performed in a PU only when the residual signal inter-channel prediction mode is selected. As such, limitation of 1PU=1TU is shown in FIG. 4. In this case, the prediction coefficient may be analytically derived.

The quadtree block structures of the luminance component and the chrominance component may be different due to the limitation in minimum transformation block. In this case, the luminance signal encoder 100 and the chrominance signal encoder 200 regenerate a first residual signal for the luminance component and a second residual signal for the chrominance component with respect to the current block group, according to a third intra-prediction mode direction of a left upper block of the current block group for the luminance component.

For example, when PART_N×N is selected in the block division units 180 and 290, PU block structure of the luminance component becomes different from that of the chrominance component. To overcome this limitation, a luminance residual signal in a block corresponding to the chrominance PU is recalculated using a prediction mode for left upper PU block of the luminance component. Just like intra DM mode for the chrominance component, the prediction mode of the chrominance component also uses left upper PU prediction mode of the luminance. As a result, the same prediction mode is applied to PU blocks of the luminance component and the chrominance component, and thus it is possible to maintain a correlation between the channels.

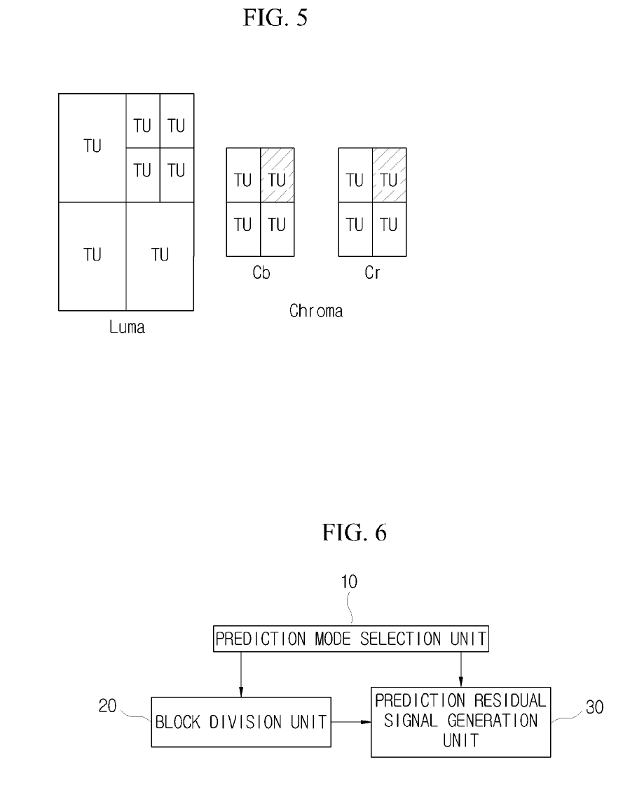

A HEVC intra prediction encoding apparatus according to another embodiment of the present invention will be described below with reference to FIG. 6.

The HEVC intra prediction encoding apparatus according to another embodiment of the present invention may include a prediction mode selection unit 10, a block division unit 20, and a prediction residual signal generation unit 30.

The prediction selection unit 10 provides an intra prediction mode including an inter-channel prediction mode (hereinafter, referred to as a residual signal inter-channel prediction mode) between residual signals of the luminance component and the chrominance component for the current block (Prediction Unit (PU)) to be encoded.

The block division unit 20 determines a quadtree block structure of the luminance component and the chrominance component of the current block.

When the residual signal inter-channel prediction mode is selected by the prediction mode selection unit 10, the prediction residual signal generation unit 30 generates a prediction residual signal for the residual signal of the chrominance component of the current block, using a first residual signal of the luminance component generated according to a first intra-prediction mode direction of the current block and a second residual signal generated according to the second intra-prediction mode direction of the current block. Here, the first residual signal is a restored signal after integer transformation and quantization, and the second residual signal is a signal before integer transformation and quantization.

The second intra prediction mode direction is the same as the first intra prediction mode direction, and thus the encoding for the second intra prediction mode direction is omitted.

As a result of block division of the block division unit 20, there may be Transform Unit (TU) division of the luminance component or the chrominance component in the current block. In this case, as an example, the prediction residual signal generation unit 30 may derive the inter-channel prediction coefficient of the TU that is first encoded in the current block as an inter-channel prediction coefficient for the current block.

Alternatively, when the residual signal inter-channel prediction mode is selected by the prediction mode selection unit 10, the block division unit 20 may limit TU division for the chrominance component in the current block.

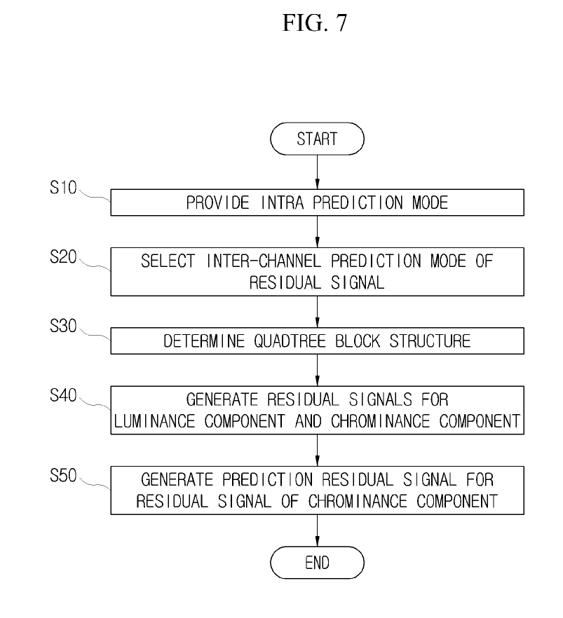

A HEVC intra prediction encoding method according to another embodiment of the present invention will be described below with reference to FIG. 7.

FIG. 7 is a flowchart showing an HEVC encoding method according to still another embodiment of the present invention.

Referring to FIG. 7, in operation S10, the prediction mode selection unit 10 provides intra prediction mode information for intra prediction of an image to be encoded.

In this case, a mode (hereinafter, referred to as a residual signal inter-channel prediction mode) of performing residual signal inter-channel prediction between a luminance residual signal and a chrominance residual signal of the current block is further provided in addition to 35 kinds (33 direction, DC, and Planar) of prediction modes defined in the luminance intra prediction.

In addition, 6 kinds (Vertical direction, Horizontal direction, DC, Planar, DM, and LM) of prediction modes, which are defined in chrominance intra prediction of HEVC, are provided.

The residual signal inter-channel prediction mode is determined by a rate-distortion optimization of an image. However, in an embodiment of the present invention, it is assumed that the residual signal inter-channel prediction mode is selected, and an encoding process after the selection is reviewed in operation S20.

Subsequently, the block division unit 20 determines a quadtree block structure of a current block group for the luminance component and a quadtree block structure of a current block group for the chrominance component and determines a quadtree block structure for the luminance component and the chrominance component of the current block in operation S30.

next, the prediction residual generation unit 30 generates a first residual signal for the luminance component of the current block according to the first intra prediction mode direction and a second residual signal for the chrominance component of the current block according to the second intra prediction mode direction in operation S40. In this case, the second intra prediction mode direction is the same as the first intra prediction mode direction.

In addition, the prediction residual signal generation unit 30 generates the prediction residual signal of the chrominance component of the current block from the first residual signal and the second residual signal on the basis of the determined quadtree block structure in operation S50. Here, the first residual signal is a restored signal after integer transformation and quantization, and the second residual signal is a signal before integer transformation and quantization.

As an example, when there is Transform Unit (TU) division in the current block, the predication residual signal generation unit 30 derives the inter-channel prediction coefficient of the TU first encoded in the current block as an inter-channel prediction coefficient for the current block. The derived inter-channel prediction coefficient is used to generate a prediction residual signal for the residual signal of the chrominance component of the current block.

As another example, the prediction residual signal generation unit 30 may limit the TU division for the chrominance component in the current block. In this case, the block division unit 20 does not perform TU division of the chrominance in the PU. As such, limitation of 1PU=1TU is shown in FIG. 4. In this case, the prediction coefficient may be analytically derived.

As a result of determination of quadtree block structures, the quadtree block structure of the current block group for the luminance component is different from that for the chrominance component. In this case, a process of regenerating a first residual signal for the luminance component and a second residual signal for the chrominance component with respect to the current block group is performed according to a third intra-prediction mode direction of a left upper block of the current block group for the luminance component.

As described above, it is possible to increase an encoding efficiency using a high similarity between the luminance component and the chrominance component that constitute one image. According to the present invention, it is possible to improve an intra-prediction encoding performance when an inter-channel prediction is performed between residual signal channels of the luminance component and the chrominance component of HEVC, and derive a prediction coefficient for linear prediction at a high speed while the quadtree block structure of the HEVC is not changed.

In addition, it is advantageous to avoid degradation in inter-channel prediction performance, which is caused when quadtree block structures of prediction units (PUs) of the luminance component and the chrominance component are different.

The intra prediction encoding method according to an embodiment of the present invention can also be implemented as computer readable codes on a computer readable recording medium. The computer readable recording medium includes all kinds of recording medium for storing data that can be thereafter read by a computer system. Examples of the computer readable recording medium may include a read only memory (ROM), a random access memory (RAM), a magnetic disk, a flash memory, optical data storage device, etc. Also, the computer readable recording medium can also be distributed throughout a computer system connected over a computer communication network so that the computer readable codes may be stored and executed in a distributed fashion.

It will be understood by those skilled in the art that various changes in form and details may be made therein without departing from the spirit and scope of the invention as defined by the appended claims. The above embodiments are accordingly to be regarded as illustrative rather than restrictive. Therefore, the scope of the invention is defined not by the detailed description of the invention but by the appended claims, and a variety of embodiments within the scope will be construed as being included in the present invention.

What is claimed is:

1. An HEVC intra prediction encoding apparatus comprising:
a luminance signal encoder configured to generate a first residual signal for a luminance component of a current block (prediction unit (PU)) being encoded according a first intra prediction mode direction for the current block;
a chrominance signal encoder configured to generate a second residual signal for a chrominance component of the current block according to a second intra prediction mode direction for the current block; and
a residual signal prediction encoder configured to when a mode (hereinafter, referred to as a residual signal inter-channel prediction mode) of performing residual signal inter-channel prediction between a luminance residual signal and a chrominance residual signal of the current block is selected, generate a prediction residual signal for a residual signal of a chrominance component of the current block using the first residual signal and the second residual signal.

2. The HEVC intra prediction encoding apparatus of claim 1, wherein when the residual signal inter-channel prediction mode is selected, the first intra prediction mode direction is the same as the second intra prediction mode direction.

3. The HEVC intra prediction encoding apparatus of claim 1, wherein when the residual signal inter-channel prediction mode is selected, encoding for the second intra prediction mode direction is omitted.

4. The HEVC intra prediction encoding apparatus of claim 1, wherein when there is Transform Unit (TU) division in the current block, the residual signal prediction encoder derives an inter-channel prediction coefficient of the TU first encoded in the current block as an inter-channel prediction coefficient for the current block.

5. The HEVC intra prediction encoding apparatus of claim 1, wherein when the residual signal inter-channel prediction mode is selected, TU division for the chrominance component is limited in the current block.

6. The HEVC intra prediction encoding apparatus of claim 1, wherein the first residual signal is a restored signal after integer transformation and quantization, and the second residual signal is a signal before integer transformation and quantization.

7. The HEVC intra prediction encoding apparatus of claim 1, wherein when a quadtree block structure of a current block group for the luminance component is different from that for the chrominance component, the luminance signal encoder and the chrominance signal encoder regenerate a first residual signal for the luminance component and a second residual signal for the chrominance component with respect to the current block group according to a third intra prediction mode direction of a left upper current block of the current block group of the luminance component.

8. An HEVC intra prediction encoding apparatus comprising:
a prediction mode selection unit configured to provide an intra prediction mode including an inter-channel prediction mode (hereinafter, referred to as a residual signal inter-channel prediction mode) between a residual signal of a luminance component and a residual signal of a chrominance component with respect to a current bock (prediction unit (PU)) to be encoded; and
a prediction residual signal generation unit configured to, when the residual signal inter-channel prediction mode is selected, generate a prediction residual signal for the residual signal of the chrominance component of the current block using a first residual signal of the luminance component generated according to a first intra prediction mode direction of the current block and a second residual signal of the chrominance component generated according to a second intra prediction mode direction of the current block,
wherein when the residual signal inter-channel prediction mode is selected, the first intra prediction mode direction is the same as the second intra prediction mode direction.

9. The HEVC intra prediction encoding apparatus of claim 8, wherein when the residual signal inter-channel prediction mode is selected, encoding for the second intra prediction mode direction is omitted.

10. The HEVC intra prediction encoding apparatus of claim 8, further comprising a block division unit configured to determine a quadtree block structure for the luminance component and the chrominance component of the current block,
wherein when there is Transform Unit (TU) division for the luminance component or chrominance component in the current block, the prediction residual signal generation unit derives an inter-channel prediction coefficient of the TU first encoded in the current block as an inter-channel prediction coefficient for the current block.

11. The HEVC intra prediction encoding apparatus of claim 8, wherein when the residual signal inter-channel prediction mode is selected, the block division unit limits TU division for the chrominance component in the current block.

12. The HEVC intra prediction encoding apparatus of claim 8, wherein the first residual signal is a restored signal after integer transformation and quantization, and the second residual signal is a signal before integer transformation and quantization.

13. An HEVC intra prediction encoding method comprising:
providing an intra prediction mode including an inter-channel prediction mode between residual signals of the luminance component and the chrominance component with respect to a current block (prediction unit (PU)) to be encoded;
when the residual signal inter-channel prediction mode is selected, generating a first residual signal for a luminance component of the current block according a first intra prediction mode direction;
generating a second residual signal for a chrominance component of the current block according to a second intra prediction mode direction; and
generating a prediction residual signal for a residual signal of a chrominance component of the current block using the first residual signal and the second residual signal.

14. The HEVC intra prediction encoding method of claim 13, wherein when the residual signal inter-channel prediction mode is selected, the first intra prediction mode direction is the same as the second intra prediction mode direction.

15. The HEVC intra prediction encoding method of claim 13, wherein when the residual signal inter-channel prediction mode is selected, encoding for the second intra prediction mode direction is omitted.

16. The HEVC intra prediction encoding method of claim 13, further comprising:
determining a quadtree block structure of a current block group for a luminance component and a quadtree block structure of a current block group for a chrominance component; and
determining a quadtree block structure for the luminance component and the chrominance component of the current block,
wherein the generating of a prediction residual signal comprises deriving an inter-channel prediction coefficient of the TU first encoded in the current block as an inter-channel prediction coefficient for the current block.

17. The HEVC intra prediction encoding method of claim 13, further comprising:
determining a quadtree block structure of a current block group for a luminance component and a quadtree block structure of a current block group for a chrominance component; and
determining a quadtree block structure for the luminance component and the chrominance component of the current block,
wherein when the residual signal inter-channel prediction mode is selected, the generating of a prediction residual signal comprises limiting TU division for the chrominance component in the current block.

18. The HEVC intra prediction encoding method of claim 13, further comprising:
determining a quadtree block structure of a current block group for a luminance component and a quadtree block structure of a current block group for a chrominance component;
determining a quadtree block structure for the luminance component and the chrominance component of the current block; and
when the quadtree block structure of the current block group for the luminance component is different from that for the chrominance component, regenerating the first residual signal for the luminance component and the second residual signal for the chrominance component with respect to the current block group according to a third intra prediction mode direction of a left upper current block of the current block group for the luminance component.

19. The HEVC intra prediction encoding method of claim 13, wherein the first residual signal is a restored signal after integer transformation and quantization, and the second residual signal is a signal before integer transformation and quantization.
